(19) United States
(12) Patent Application Publication
(10) Pub. No.: US 2022/0122075 A1
(43) Pub. Date: Apr. 21, 2022

(54) TEMPLATE-DRIVEN DISTRIBUTED ELECTRONIC TRANSACTION DATA VALIDATOR

(71) Applicant: Wells Fargo Bank, N.A., San Francisco, CA (US)

(72) Inventors: Jennifer Dione Bardouille, West St. Paul, MN (US); Sean Christopher Goldrick, Cockeysville, MD (US); Diane Lynn Hoehne, Prior Lake, MN (US); Wiyomi Rustia Quion, Apple Valley, MN (US)

(21) Appl. No.: 15/583,850

(22) Filed: May 1, 2017

Related U.S. Application Data
(60) Provisional application No. 62/440,347, filed on Dec. 29, 2016.

(51) Int. Cl. G06Q 20/40; G06Q 20/08

(52) U.S. Cl. CPC G06Q 20/405; G06Q 20/085

(57) ABSTRACT

Techniques and systems are disclosed for performing data validation in distributed settings, to enable data validation of an electronic transaction request or command based on a template and validation definitions. In an example, techniques for data validation may include obtaining information processing rules for validating electronic data that is used to perform a financial transaction in a locality (e.g., internationally), generating an electronic data validation template for the locality using the validation rules, and transmitting the electronic data validation template to a computing device for use in validating electronic data using the one or more data field definitions. In further examples, the validation rules may indicate one or more payment validation rules, bank validation rules, or chronology rules. The validation may be automatically deployed to client systems (such as in an enterprise resource planning system) or incorporated into a server as part of data file processing.

### CLAIM OF PRIORITY

This patent application claims the benefit of priority, under 35 U.S.C. § 119, to U.S. Provisional Application Ser. No. 62/440,347, titled “TEMPLATE-DRIVEN DISTRIBUTED ELECTRONIC TRANSACTION DATA VALIDATOR” and filed on Dec. 29, 2016, the entirety of all are hereby incorporated by reference herein.

### TECHNICAL FIELD

Embodiments described herein generally relate to electronic processing activities occurring in the field of electronic data validation, and in particular, but not by way of limitation, to a distributed electronic data validator for defined transactions and transaction types.

### BACKGROUND

Electronic data transactions are used in a variety of settings, including in connection with financial processing actions of electronic international financial transactions. A variety of standards have been defined to specify the format, type, and acceptable range of values used to initiate or perform such electronic international financial transactions. However, even if such standards are followed, there may be many other timing, regulatory, or information requirements and constraints (including errors, informalities, missing information) that prevent an electronic international financial transaction from being successfully performed. As a result, many electronic international financial transactions are rejected or are performed incorrectly, leading to cost and delay and error conditions in electronic processing systems. Further, although some service providers may attempt to perform validation before executing a particular electronic international financial transaction, such information is often manually validated by humans, leading to additional cost, delay, and the possibility of human error.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram of an environment in which a transactional rules engine may be implemented, according to various examples;

FIG. 2 is a diagram of a transactional rules engine, according to various examples;

FIG. 3 illustrates a template validation process using a template validator of a transactional rules engine, according to various examples;

FIG. 4 illustrates an electronic data validation process for an electronic data validator, according to various examples;

FIGS. 5A and 5B illustrate an entity relationship diagram for a template-driven distributed electronic data validator, according to various examples;

FIG. 6 is a flowchart of a method of generating an electronic data validation template within a template-driven distributed electronic data validator, according to various examples;

FIG. 7 is a flowchart of method of validating electronic data using an electronic data validator, according to various examples;

FIG. 8 is a block diagram of a machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Data requirements for electronic international financial transactions (e.g., payments, transfers, etc.) may be complex and employees of an organization (e.g., business, non-profit, etc.) may have little expertise in international transactions. For example, employees of the organization may not be aware of the type of data, formats, local transaction rules, or in-country rules regarding transaction data file content. This may lead to foreign financial transaction data files being submitted with incorrect formats, data fields, data values, etc. In addition, the electronic data file submitted for a specific transaction may not meet transaction requirements or standards of an institution or locality receiving the electronic data file. As a result, international financial transactions (e.g., Society for Worldwide Interbank Financial Telecommunication (SWIFT) messaging transaction, International Organization of Standards (ISO) 15022 messaging transaction, ISO 20022 messaging transaction, etc.) may encounter failures or rejection, may require manual corrections with human intervention, or may be lost (e.g., discarded, incorrectly routed, etc.).

Although some approaches of transaction data validation functionality may be invoked in various parts of the transaction processing flow, there may be inconsistencies in what data is validated across the organization's internal applications, a financial institution, vendor solutions, and the financial industry as a whole. With existing approaches, electronic data validation rules may be pieced together from a variety of sources including local clearinghouses, SWIFT, government agencies, internal financial institution operations, and the organization. The disparate information for electronic data validation may be inconsistent from system to system, with each having different (or the same) inconsistencies that lead to failed or delayed transactions. Human intervention may be indicated for tracking down and rectifying incorrect or missing validation rules across the various transaction processing systems between the organization and the other party to the transaction which may lead to inefficiencies in transaction processing.

The presently disclosed systems and techniques provide for the generation of a centrally managed electronic data validation template that may be distributed to transaction processing systems at the point of electronic data file creation. The systems and techniques provide consistent electronic data validation before a file is transmitted reducing lost transactions, delays, and human intervention, thus resulting in more efficient transaction processing.

As discussed herein, the present systems and techniques are applicable to a template-based distributed electronic data validator. Further, although the present systems and techniques are discussed in the context of international financial transactions, it will be understood that the techniques may be used for the validation of any number of information types relating to electronic data and/or electronic data files (e.g., order entry systems, identification systems, etc.).

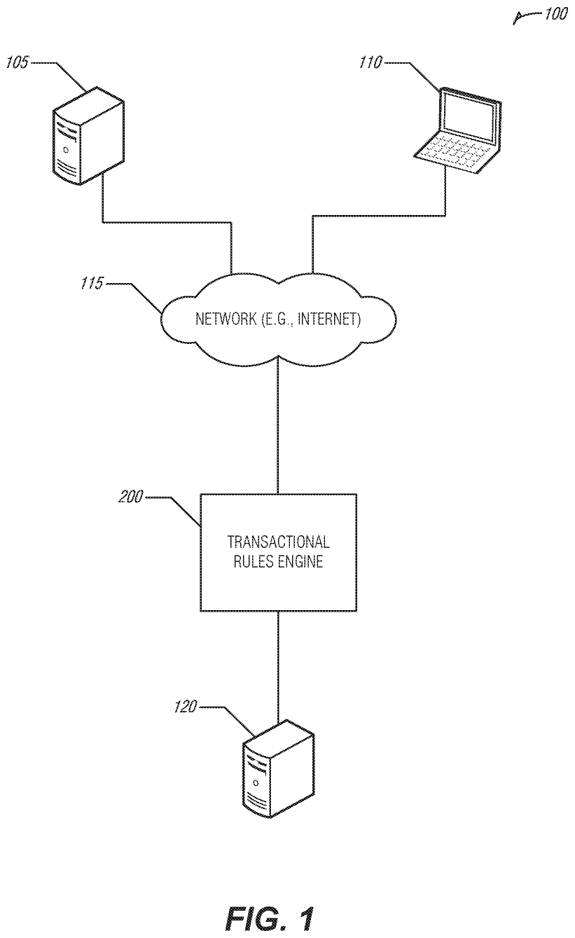

FIG. 1 a diagram of an environment 100 in which a transactional rules engine 200 may be implemented, according to various examples. FIG. 1 specifically illustrates a scenario in which clients are used to transmit electronic data files (e.g., a collection of inputs and values corresponding to forms, definitions, web forms, transaction files, etc.) for international financial transactions. The environment 100 may include an organizational server 105 and a client device 110 that communicate via the network 115 (e.g., the internet, an extranet, etc.) with an institution hosting the transactional rules engine 200 and transaction processing servers such as transactional server 120 (e.g., web server, financial application server, etc.).

The organizational server 105 may be hosting a variety of organizational computing systems that are used for generating financial transaction such as, for example, an enterprise resource planning (ERP) system, an accounting system, etc. The organizational server 105 may generate electronic data files for a transaction or a batch of transactions that may be transmitted to a financial institution for processing. The organizational server 105 may use a variety of electronic data entry forms that may be automatically or manually completed with transactional details (e.g., payee, amount, account numbers, routing numbers, etc.). The form, including entered data, may be transmitted as an electronic file to a financial institution for processing.

The client device 110 may be used by an employee of an organization to enter electronic data for financial transactions. The client device 110 may communicate with a web server hosting a financial application (e.g., a web-based financial transaction system of a financial institution, etc.). The web server may include a variety of forms for initiating transactions. For example, the web server may present a payment form presenting the employee with fields for imputing transactional details. The payment form, including entered data, may be transmitted as an electronic data file for further processing by the financial institution. In some examples, the organizational server 105 and/or the client device 110 may generate an electronic data file which may be transmitted to a financial institution for processing. While examples used herein may refer to payment, it will be understood that the techniques described herein are applicable to other transactions including, but not limited to fund transfers, currency exchanges, purchases, etc.

The transactional server 120 may generate and/or receive electronic data files for processing transactions. In some examples, the transactional server 120 may be a web server with which the client device 110 communicates to complete transactional web forms. The transactional server 120 may process received electronic data files to prepare them for internal processing and/or to be forwarded on to another financial institution (e.g., another financial institution, foreign financial institution, etc.) for processing (e.g., to complete payment, funds transfer, etc.).

The transactional rules engine 200 may include a variety of components for validating electronic data. The transactional rules engine 200 may compile transactional rules from various sources such as, for example, regulatory rules for a locality (e.g., country, region, municipality, etc.), foreign processing rules from a foreign financial institution, time and/or date rules for transactions from the foreign financial institution, internal processing rules for the financial institution, etc. into one or more rulesets. In an example, the transactional rules may include preferences of financial institutions, vendors, etc. that may be used to provide data in a format preferred by a recipient and/or processing party. The preferences may include data fields, data field rules, etc. used by the recipient and/or processing party in completing a transaction. The preferences may be additional to or alternative to rules provided in a ruleset. For example, a preference may define the format of an input field corresponding to a rule provided by a regulatory body. The rulesets may define a set of transactional processing rules for a transactional scenario such as a foreign financial transaction destined for a foreign financial institution in a locality.

The rulesets may be used to generate an electronic data validation template that is centrally managed (e.g., on a central server computer, computing system, etc.). The electronic data validation template may include a variety of data field definitions including data value rules (e.g., formatting, length, character type, required field, etc.). The electronic data validation template may be distributed to a variety of systems which generate and/or process electronic data files such as the organizational server 105 (e.g., via an application plugin, application program interface (API), etc.). The electronic data validation template may be used in validating electronic data entered into various forms provided by the organizational server 105 to a client computing device.

In some examples, the template may be used by the organizational server 105 in the generation of the forms. For example, the organizational server 105 may include a payment form and the electronic data validation template may be used to automatically modify the payment form to include the field definitions included in the electronic data validation template. In another example, the organization may to build a payment form and may use the electronic data validation template to validate the content (e.g., fields, field definitions, etc.) of the payment form. In another example, the organization may add a new vendor to an ERP system and the vendor may be located in a country to which the organization has not previously sent payments. An application plugin may be installed in the ERP system that uses the electronic data validation template to ensure a payment contains the correct bank and beneficiary information for that country.

Additional or alternatively, the electronic data validation template may be used by an electronic data validator of a web server or other system providing electronic data entry forms for use in initiating transactions. For example, a financial institution website may include an electronic data validator that may use the electronic data validation template to validate data entered into fields of the forms. In some examples, a user may be presented an indication that data entered in a field does not meet the validation rules. In an example, information in the electronic data validation template may be used by the electronic data validator to modify (e.g., correct, etc.) the data entered into the field. For example, an account number may be entered with leading zeros and the leading zeros may be trimmed from the account number. In an example, messages indicating errant or questionable data may be presented for electronic data that is received in real-time from user data entry.

In some examples, the transactional rules engine 200 may update the rulesets and corresponding electronic data validation templates upon receiving updated transaction rules. For example, a new regulatory rule may be received indicating that a new field is required for processing transactions in a locality and an electronic data validation template for generating electronic data files in the locality may be updated to include the new field and corresponding field definition. The updated electronic data validation template may be transmitted (e.g., using the plugin, API, direct data pull, etc.) to the systems using the electronic data validation template for electronic data validation. Thus, each system may use the most current electronic data validation template to improve electronic data consistency across each electronic data entry platform.

In some examples, an electronic data file and/or an electronic data validation template may be scrubbed (e.g., data may be modified, removed, etc.) using the electronic data validation template and/or ruleset(s). For example, payment numbers and content (e.g., electronic data fields, electronic data filed values, etc.) may be scrubbed from a payment file and/or a payment form received from an organization. This may prevent organization specific data from being place in the transaction processing stream which may cause a processing error. In some examples, the scrubbing may be completed by the client using an electronic data validator. Thus, the electronic data validation templates may be managed centrally while the validation process is distributed among clients such as, for example, organizational server 105 and client device 110.

In some examples, the electronic data validation template may include instructions for validating data values entered in a data field using another system (e.g., account database, routing number database, customer database, account verification system, etc.). For example, the electronic data validation template may include instructions for an account number data field that trigger a query (e.g., upon the field losing focus, upon form submission, etc.) for an account database to verify that an account number entered in the account number data field matches an account number in an account database of a financial institution. In some examples, the query may return an account status (e.g., whether the account is open, whether the account is restricted, whether certain locality or regulatory rules apply, etc.). In another example, the instructions may trigger a query of a customer database of the financial institution using an organization name and the account number to verify that the account number entered is correct for the organization. These instructions may reduce transaction error in cases where the organization's account number has changed. In addition, verifying the account number and organization name are associated may reduce incidents of fraud.

In some examples, the validation operations may be specific to an organization (e.g., a customer, a payee, etc.) The validation rules in an electronic data validation template may include filtering rules that may, for example, exclude certain types of information, access more detailed information (e.g., using organization specific data querys, etc.), analyze historical information to determine impacts of invalid data for a particular filed, etc. In some examples, the filter may determine rules that should be enforced during validation such as, for example, which countries and types of payments are most important (e.g., as determined by financial impact, a priority level assigned to a country or payment type, etc.), organizational rules for applying payments, etc.

In some examples, an electronic data validator may use the electronic data validation template to present a user with a display indicating a value entered in a data field is incorrect. For example, the organization may have change an account number at a financial institution and a user may have entered the old account number. The electronic data validation template may be used by the electronic data validator to indicate that the account number is no longer correct. For example, the electronic data validator may use the organization name from an organization name data field and the old account number to query a customer database and present a prompt to correct the account number based on the account number being found in a list of previous account numbers for the organization. In some examples, the electronic data validator may automatically update the field with the correct database and may prompt the user for verification.

In some examples, the electronic data validation template may include instructions for identifying a preferred transaction type for the transaction. For example, an organization may have previously paid a vendor via a check to a foreign financial institution and the foreign financial institution may now require payments to be transmitted via wire transfer or via automated clearing house (ACH). The electronic data validation template may convert check information entered by a user to the correct format for a wire transfer or and ACH deposit. In some examples, the user may be provided with graphical information indicating the information from a check transaction (e.g., fields, etc.) used to establish a wire transfer or ACH deposit.

In some examples, the transactional rules engine 200 may provide a graphical user interface (e.g., web portal, etc.) with content providing the user with an indication of transaction success and failure rates. The transactional rules engine 200 may use machine learning techniques to identify patterns in failed transactions to identify data fields and/or data field values that correspond with the failures. For example, several failed transactions may be missing a portion of a routing number and the missing routing number may be identified as a cause of the failed transactions. The user may be provided in the graphical user interface the identification of the missing routing number digits and an indication of how to remedy the issue. Additionally or alternatively, the transactional rules engine 200 may modify an electronic data validation template corresponding to the transactions to update the routing data field definition to include the correct number of digits.

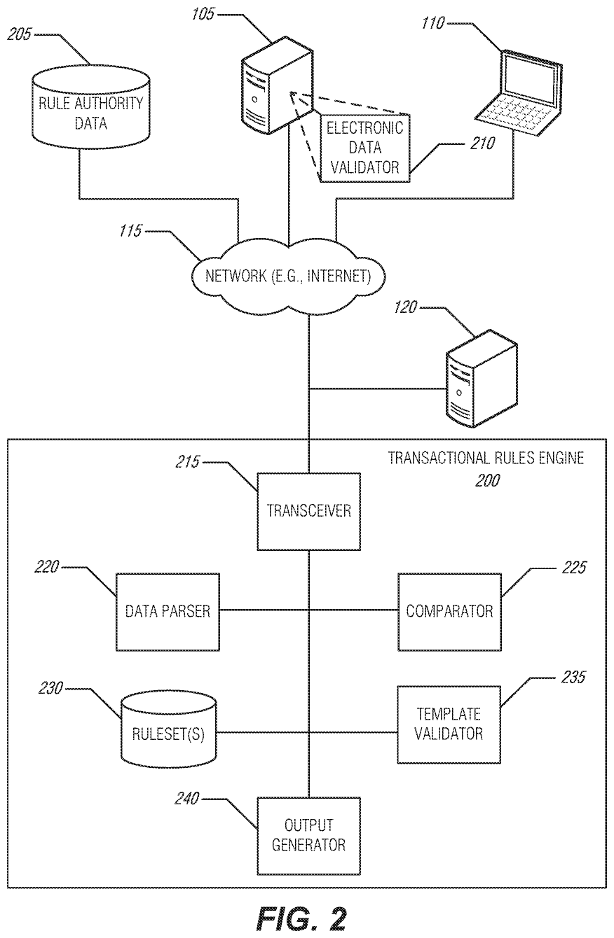

FIG. 2 is a diagram of a transactional rules engine 200, according to various examples. The transactional rules engine 200 may provide the functionality described in FIG. 1. The transactional rules engine 200 may include a variety of components such as a transceiver 215, data parser 220, comparator 225, ruleset(s) 230, template validator 235, and output generator 240. While not directly a part of the transactional rules engine 200, the rule authority data 205, organizational server 105, client device 110, and the transactional server 120 may be communicatively coupled (e.g., using the transceiver 215 via the network 115, wired network, wireless network, etc.) to the transactional rules engine 200. The organizational server 105 may include an electronic data validator 210 that may be communicatively coupled (e.g., using a plug-in, API calls, etc.) to the transactional rules engine 200.

The organizational server 105 may be part of a variety of systems of an organization capable of initiating financial transactions such as, for example, an enterprise resource planning (ERP) system, a web server, etc. The organizational server may provide a variety of user interfaces for entering transaction details (e.g., account number, payee, payor, etc.). In some examples, the organizational server 105 may automatically initiate transactions. Electronic transactions generated at the organizational server 105 may create an electronic data file including electronic data used in processing a transaction (e.g., by a financial institution, etc.).

The transactional server 120 may generate and/or process financial transactions. The transactional server 120 may be a web server or application server running a variety of financial processing applications (e.g., online banking, payment processing, etc.). In some examples, the transactional server 120 may provide user interfaces allowing a user to enter financial transaction details. In some examples, the transactional server 120 may receive electronic data files including financial transaction details.

The client device 110 may communicate with one or more systems capable of initiating financial transactions such as, for example, the organizational server 105 and/or transactional server 120. The client device 110 may be used to enter financial transaction details using one or more user interfaces provided by a financial transaction system. In some examples, the client device 110 may include a standalone application for initiating financial transactions. The client device 110 may create, either individually or in conjunction with a financial transaction system, an electronic data file including electronic data used to process the transaction.

The rule authority data 205 may be a variety of data sources (e.g., databases, websites, electronic files, etc.) containing transactional rules. For example, the rule authority data 205 may include financial regulations, financial institution transaction processing rules, foreign financial institution transaction processing rules, chronology (e.g., time, date, etc.) rules for localities, etc.

The transceiver 215 may process incoming and outgoing data. The transceiver 215 may forward incoming data to other components of the transactional rules engine 200 such as the data parser 220, the comparator 225, the template validator 235, and the output generator 240. For example, the transceiver 215 may receive an electronic data file from the organizational server 105, the client device 110, and/or the transactional server 120 which may be forwarded to the data parser 220.

The transceiver 215 may receive data from components of the transactional rules engine 200 for outgoing transmission to the organizational server 105, client device 110, and/or the transactional server 120. For example, an electronic data validation template may be transmitted via the transceiver 215 to the electronic data validator 210 included in the organizational server 105.

The data parser 220 may process inputs received from the transceiver 215. For example, the data parser 220 may process data from the rule authority data 205 and/or electronic data files received (e.g., from the transceiver 215) from the organizational server 105, client device 110, and/or the transactional server 120. The data parser 220 may evaluate the data received to identify a variety of information such as electronic data fields, electronic data field values, validation rules, etc. For example, the data parser 220 may receive regulation data from a financial authority of a locality and may identify transactional rules for the locality. In another example, the data parser 220 may receive an electronic data file from the organizational server 105 and may identify an account number electronic data field with an electronic data field value (e.g., of 1234567890).

The data parser 220 may forward the identified information to the comparator 225. The comparator 225 may evaluate rule information to determine validation rules from the rule information and may generate ruleset(s) 230 using the validation rules. The ruleset(s) 230 may include validation rules obtained from the rule authority data 205. For example, the comparator 225 may determine a ruleset using validation rules from a regulatory body for transactions destined for a locality under the control of the regulatory body. The ruleset(s) 230 may include a variety of validation rules for processing transactions including payment validation rules, chronology rules (e.g., date, time, daily cutoff time, holidays, etc.), and bank validation rules. The ruleset(s) 230 may define requirements, preferences, limitations, etc. for processing a transaction in a given scenario (e.g., in a locality, etc.). The ruleset(s) 230 may be stored in a database, file, memory, or other suitable electronic storage facility.

In some examples, the comparator 225 may receive a set of electronic data files and a set of corresponding transaction processing results. The comparator 225 may use a variety of machine learning techniques (e.g., supervised learning, unsupervised learning, clustering, etc.) to identify patterns in the electronic data files causing transactions to fail. For example, a set of electronic data files may have resulted in a failure to process payments in France because several of the electronic data files had an improperly formatted routing number. A particular routing number format may be identified as a validation rule for payments transactions to France and may be added to the ruleset(s) 230 and used in creating and/or modifying an electronic data validation template for payments to France.

The comparator 225 may generate an electronic data validation template using the ruleset(s) 230. For example, the comparator may identify a ruleset applies to payments made in France and may generate an electronic data validation template for payment transactions in France. The electronic data validation template may include a variety of electronic data fields, electronic data field definitions, computer instructions, etc. defining acceptable content for completing a transaction. For example, an electronic data validation template for payments to be deposited at French banks may include an account number field of ten characters with instructions to query a financial institution to verify an account number value in a payee account number electronic data field corresponds to an organization name value of a payee electronic data field and that the account corresponding to the account number value is in good standing (e.g., account open, sufficient funds, not on a restricted list, etc.).

The comparator 225 may work in conjunction with the output generator 240 and the transceiver 215 to transmit the electronic data validation template to the organizational server 105, client device 110, transactional server 120, etc. for use in validating electronic data files and/or electronic data value entries. In some examples, the electronic data validator 210 may be used by a transaction initiation system such as organizational server 105 for validating the electronic data files and/or electronic data value entries.

The electronic data validator 210 may be an application plugin (e.g., an add-in component for an ERP system, etc.), an application capable of making API calls to the transactional rules engine, or other application extension providing a connection to the transactional rules engine 200. The electronic data validator 210 may receive the electronic data validation template and may validate data as it is entered (e.g., as electronic data field values are typed into a form, etc.) or upon creation of an electronic data validation file (e.g., when a form is submitted, etc.) using the included validation rules.

In some examples, an electronic data validation template may be received by the transactional rules engine 200. For example, an ERP system may generate a payment form for payments to France and the form may be received as an electronic data validation template. The template validator 235 may evaluate the received electronic data validation template and may work in conjunction with the comparator 225 to determine whether the validation rules of the received electronic data validation template match an authoritative electronic data validation template. For example, the ERP's form for payments to France may be evaluated using an electronic data validation template for payments to France.

In some examples, the received electronic data validation template may be evaluated using the ruleset(s) 230 to determine if validation rules included in the received electronic data validation template comply with the ruleset(s) 230. The template validator 235 may work in conjunction with the output generator 240 to modify the received electronic data validation template to include a valid set of validation rules based on the authoritative electronic data validation template and/or the ruleset(s) 230. The modified electronic data validation template may be transmitted (e.g., using the transceiver 215) back to the sender for use in electronic data validation. In the event that no modifications were made to the received electronic data validation template, the output generator 240 may generate a message indicating that the received electronic data validation template is valid.

The electronic data validation template may be updated based on receipt of new rules, modified rules, etc. and the template validator 235 may work in conjunction with the comparator 225 to modify the electronic data validation template to add and/or modify validation rules included in the electronic data validation template. The output generator 240 may prepare the updated electronic data validation template for transmission (e.g., via plugin, API, push, pull, etc. using the transceiver 215) to the organizational server 105, client device 110, transactional server 120, and other systems initiating transactions. Thus, each subscribed system (e.g., systems connected to the transactional rules engine, etc.) may use the same electronic data validation template for validating electronic data in the electronic data files which may result in more consistent transaction processing results.

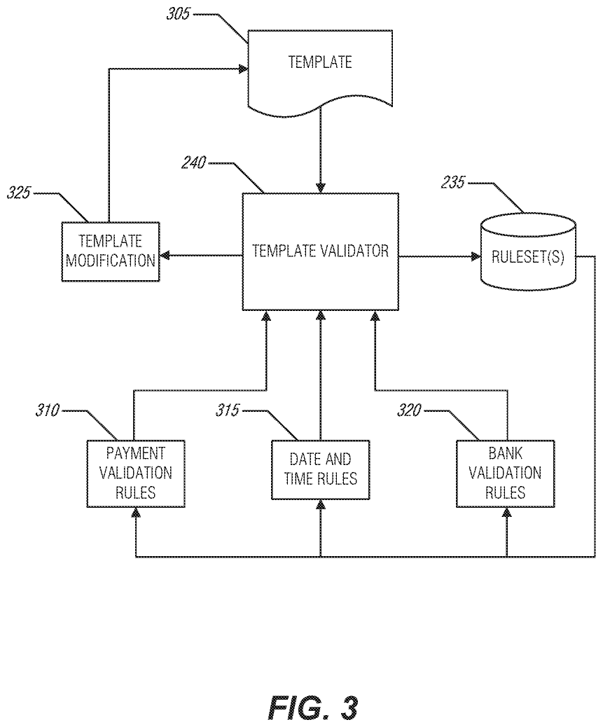

FIG. 3 illustrates an example template validation process 300 using a template validator of a transactional rules engine, according to various examples. The template validation process 300 may provide functionality as described in FIGS. 1 and 2. The template validation process 300 may be an operation of the template validator 235 as described in FIG. 2. The template validator may receive (e.g., via the transceiver 215 as described in FIG. 2) an electronic data validation template 305. For example, an enterprise resource planning (ERP) system may transmit a payment form to the template validator 235 to validate that validation rules included in the form are valid. The template validator 235 may identify a transaction scenario (e.g., payment to a foreign locality, etc.) to which the electronic data validation template applies.

The template validator 235 may access the ruleset(s) 230 to identify validation rules corresponding to the transaction scenario (e.g., for the locality, etc.). The validation rules may include payment validation rules 310 (e.g., validation rules for making payments in a locality, etc.), data and time rules 315 (e.g., chronology rules defining when transactions should be submitted, etc.), and bank validation rules 320 (e.g., rules for processing a transaction using a financial institution, etc.).

The template validator 235 may evaluate the received electronic data validation template 305 using the payment validation rules 310, data and time rules 315, and bank validation rules 320 to identify if validation rules in the received electronic data validation template 305 are valid (e.g., are the rules sufficient to implement the rules, etc.). If the received electronic data validation template 305 is valid, the template validator 235 may transmit a message to the sending system indicating that the received electronic data validation template 305 is valid. If the template validator 235 determines that the received electronic data validation template 305 is not valid, the template validator 235 may generate a template modification 325. The template modification 325 may include new and/or modified electronic data fields, computer instructions, electronic data field definitions, etc. The template modification 325 may be applied to the received electronic data validation template 305 and the modified electronic data validation template may be transmitted to the sending system.

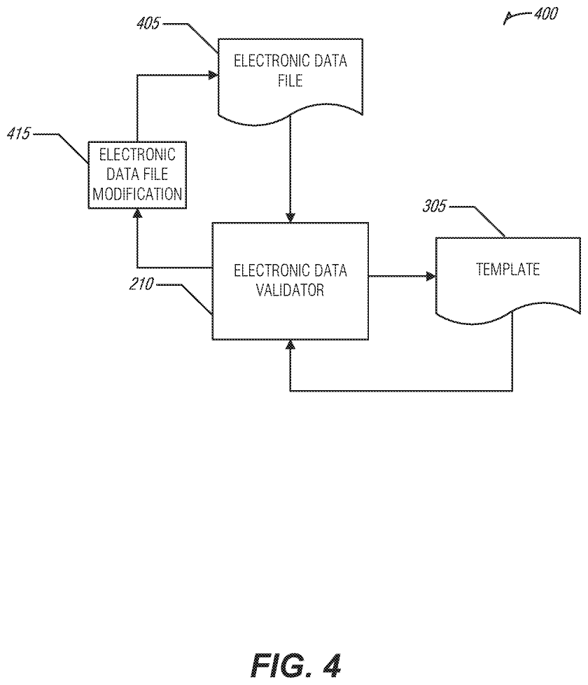

FIG. 4 illustrates an example electronic data validation process 400 for an electronic data validator 210, according to various examples. The electronic data validation process 400 may provide functionality as described in FIGS. 1 and 2. The electronic data validation process 400 may be an operation of the electronic data validator 210 as described in FIG. 2. The electronic data validator 210 may receive an electronic data file 405 including electronic data for processing a transaction. In some examples, the electronic data may be received in real-time during data entry. The electronic data validator 210 may be operating on a system where financial transactions are initiated such as, for example, organizational server 105, client device 110, and/or transactional server 120 as described in FIG. 2.

The electronic data file 405 may be evaluated by the electronic data validator 210 to determine a transaction scenario (e.g., payment to a foreign locality, etc.) for the electronic data file 405. The electronic data validator 210 may identify an electronic data validation template 305 corresponding to the transaction scenario. For example, an evaluation of the electronic data file may indicate that the electronic data file is for a payment being made to France and an electronic data validation template for payment to France may be selected.

The electronic data validator 210 may evaluate the electronic data file 405 using the selected electronic data validation template 305 to determine if the data in the electronic data file 405 complies with the validation rules included in the electronic data validation template 305. For example, electronic data field values may be compared to electronic data field definitions to determine if the electronic data field values comply with the electronic data field definitions (e.g., have the correct number of digits, correct character types, etc.). Computer instructions included in the electronic data validation template may be executed to complete additional validations such as, for example, verifying that an account number in the electronic data file corresponds to an organization name in the electronic data file, that an account number in the electronic data file corresponds to an account that is in good standing, etc.

If the electronic data validator 210 determines that the electronic data file 405 is valid, the electronic data file 405 may be forwarded on for further processing of the transaction. If the electronic data validator 210 determines that the electronic data file 405 is not valid, the electronic data validator 210 may use the validation rules from the electronic data validation template 305 to generate an electronic data file modification 415. The electronic data file modification may use the rules to replace data identified as invalid with valid data. For example, an account number in the electronic data file may have leading zeros such as 000123456789 and the electronic data file modification may include a replacement account value of 123456789.

In some examples, the electronic data validator 210 may not be able to identify a modification that can change the electronic data file to become valid. In such cases, the electronic data validator 210 may include in the electronic data file modification an indication to be displayed to a user indicating the presence of invalid data. For example, the electronic data file modification may include graphical user interface elements to be displayed to a user indicating invalid value for an electronic data field, missing value for an electronic data field, account/organization mismatch, account not in good standing, etc. Thus, the electronic data file 405 may not be transmitted beyond the point of entry until the electronic data file 405 has been validated, accordingly reducing traffic and processing load at upstream transaction processing systems.

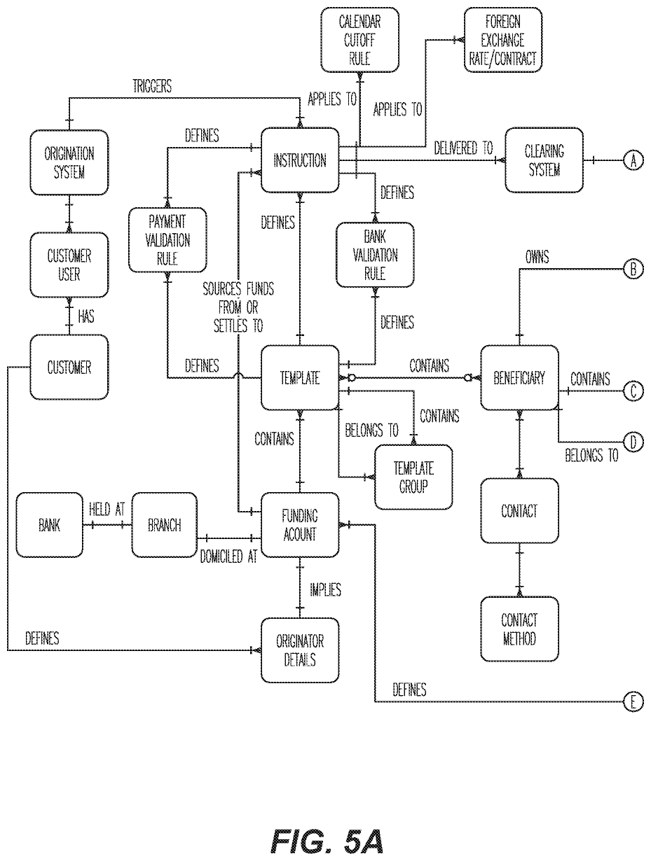

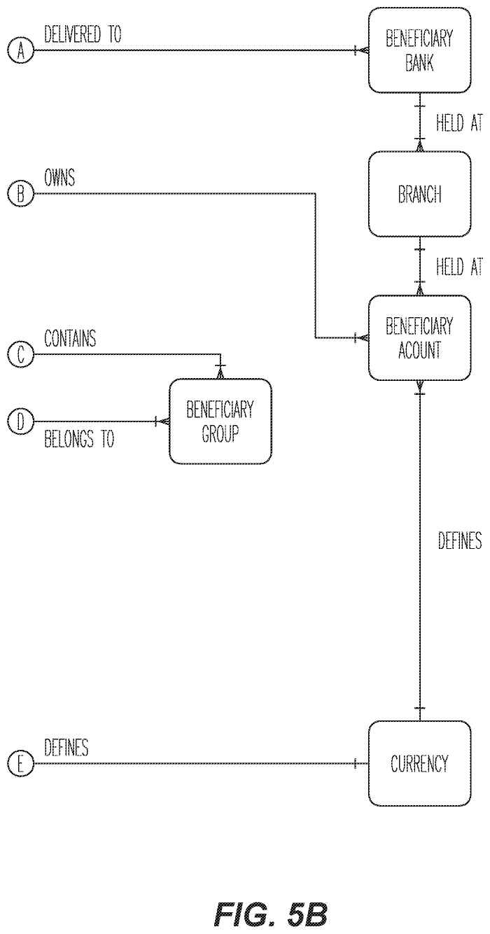

FIGS. 5A and 5B illustrate an example of an entity relationship diagram for a template-driven distributed electronic data validator, according to various examples. The entity relationship diagram describes the relationship between an electronic data validation template (e.g., electronic data validation template 305 as described in FIGS. 3 and 4) and other entities involved in specific foreign financial transaction processing configurations. Thus, it will be understood that the preceding examples may be constrained or expanded by the particular relationships between entities, rules, and systems, such as those depicted in FIGS. 5A and 5B. The entity relationship diagram may be used in conjunction with the techniques disclosed herein to address the following types of validation: country (e.g., country codes, allowed countries, etc.), currency (e.g., United States Dollar, etc.), currency pairs (e.g., United States Dollar and British Pound, etc.), mandatory fields (e.g., bank details, beneficiary name, beneficiary address, etc.), country specific required content (e.g., phone numbers, special codes, etc.), local and regional clearing network information (e.g., bank identification numbers, routing information, etc.), vendor information (e.g., name, location, account, bank details, etc.), and customer specific content rules.

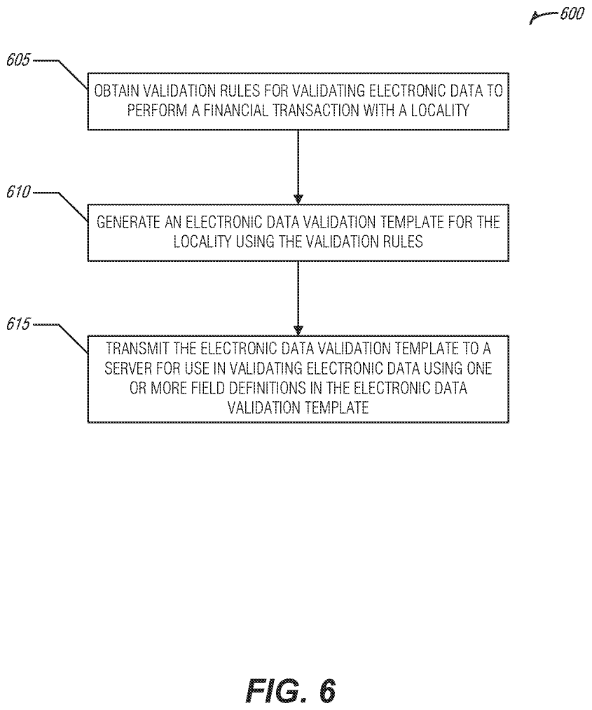

FIG. 6 is a flowchart of an example method 600 of generating an electronic data validation template within a template-driven distributed electronic data validator, according to various examples. The method 600 may be performed by any of the components, logic, or systems described herein. Further, the order and type of the operations depicted in the flowchart of the method 600 may be added, modified, or substituted using any of the operations or functions described above.

At operation 605, validation rules are obtained for validating electronic data to perform a financial transaction with a locality (e.g., country, state, territory, city, region, or like construct). The validation rules include a payment validation rule, a bank validation rule, and a chronology rule. In an example, rule data is obtained from a rule authority data source of the locality and at least one of the payment validation rule or the chronology rule is determined using the rule data. In another example, bank rule data is obtained from a bank rule data source of a financial institution and at least one of the payment validation rule, the bank validation rule, or the chronology rule is determined using the bank rule data. In some examples, the validation rules may include rules for formatting the electronic data in compliance with a SWIFT, ISO 15022, or ISO 2022 messaging standard.

In some examples, transaction data and transaction results may be obtained corresponding to transaction for the locality. A data field in the transaction data indicated in transaction results as causing a failure of a plurality of the transactions may be determined. The data field in the transaction data corresponding to each transaction of the plurality of transaction may be analyzed to determine a pattern. The payment validation rule, the bank validation rule, or the chronology rule may be determined using the pattern.

In some examples, transaction data and transaction results may be determined that correspond to transactions for the locality. A value of a data field in the transaction data indicated in the transaction results in causing a failure of a plurality of the transactions may be determined. The value of the data field in the transaction data corresponding to each transaction of the plurality of transactions may be analyzed to determine a pattern. The payment validation rule, the bank validation rule, or the chronology rule may be determined using the pattern.

At operation 610, an electronic data validation template is generated for the locality using the validation rules. The electronic data validation template includes one or more data field definitions for electronic data entry based on the payment validation rule, the bank validation rule, and the chronology rule. In some examples, second validation rules are obtained for validating the electronic data and the electronic data validation template may be adaptively modified using the second validation rules.

At operation 615, the electronic data validation template is transmitted to a server for use in validating electronic data using the one or more data field definitions. In an example, the server is an enterprise resource planning (ERP) system and the electronic data validation template modifies a display provided by the ERP system. In another example, the server is a web server and the electronic data validation template modifies a web page served by the web server.

In some examples, an electronic data files is obtained. The electronic data file is compared to the electronic data validation template. An electronic data field of the electronic data file may be modified based on the comparison. In some examples, an electronic data file is obtained. The electronic data file is compared to the electronic data validation template and a value of an electronic data field of the electronic data file is modifies based on the comparison.

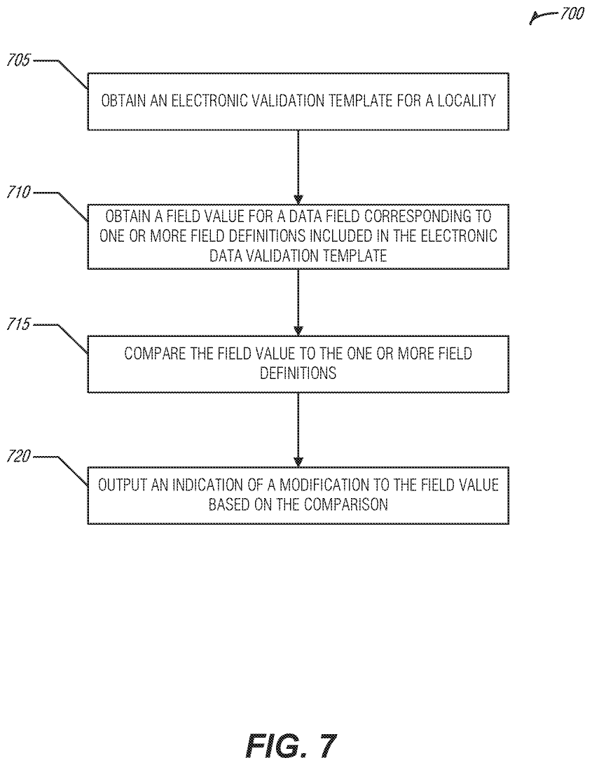

FIG. 7 is a flowchart of an example method 700 of validating electronic data using an electronic data validator, according to various examples. The method 700 may be performed by any of the components, logic, or systems described herein. Further, the order and type of the operations depicted in the flowchart of the method 700 may be added, modified, or substituted using any of the operations or functions described above.

At operation 705, an electronic data validation template is received for a locality. The electronic data validation template includes one or more data field definitions for electronic data entry based on a payment validation rule, a bank validation rule, and a chronology rule. In an example, the electronic data validation template is obtained in response to selection of the locality from a locality section user interface element.

At operation 710, a field value for a data field corresponding to the one or more data field definitions are obtained. This may occur from parsing data from a data file or processing data provided within a user input.

At operation 715, the data field value is compared to the one or more data field definitions. This may include use of logic to identify similarity or correspondence (e.g., with fuzzy logic, matching rules, machine learning training, etc.)

At operation 720, an indication of a modification to the data field value is displayed on a display device based on the comparison. In an example, the indication of a modification includes modifying the display of the field data value. In another example, the indication of a modification includes displaying a message indicating invalidity of the data field value on the display device. In some examples, validation statistics may be collected and used in tuning validation rules included in one or more electronic data validation templates to increase validation accuracy.

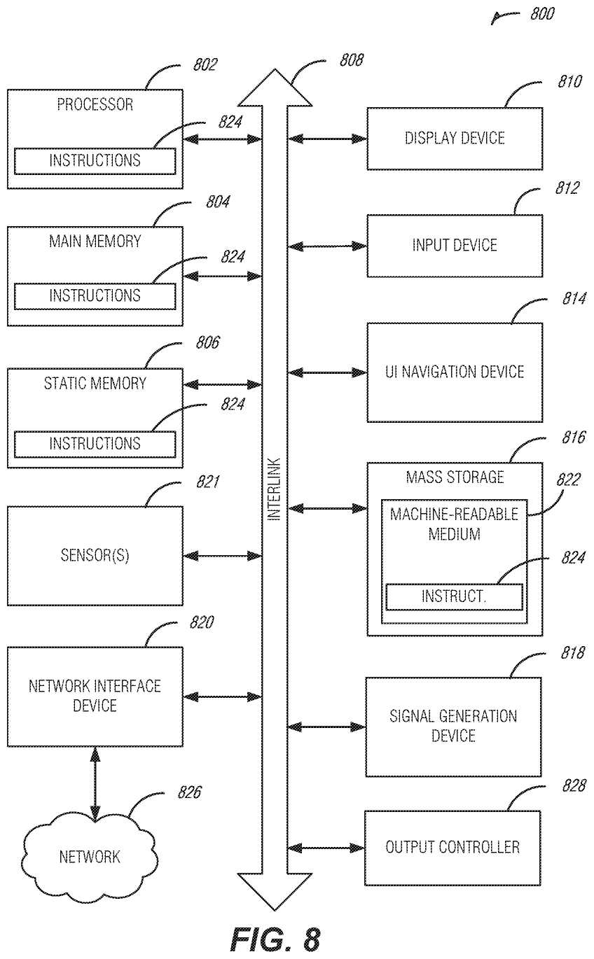

FIG. 8 illustrates a block diagram illustrating a machine in the example form of a computer system 800, within which a set or sequence of instructions may be executed to cause the machine to perform any one of the methodologies discussed herein for implementation of the electronic operations of a dynamic interaction processing system, according to an example. In an example, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a thin client, a tablet PC, a hybrid tablet, a personal digital assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus or interconnect). The computer system 800 may further include a video display unit 810, an input device 812 (e.g., an alphanumeric keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, location sensor, or other sensor. For example, the features of the input device 812, the UI navigation device 814, and the video display unit 810, may be used to output and control the graphical user interfaces described above for the present dynamic interaction processing system.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). The communications with the communication network 826 optionally may occur using wireless transmissions sent via one or more antennas 828. Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any medium that is capable of storing, encoding, or carrying instructions for execution by the machine, and includes digital or analog communications signals or other mediums to facilitate communication of such software.

Moreover, the devices and subsystems of the present examples may communicate via one or more networks, which may include one or more of local-area networks (LAN), wide-area networks (WAN), wireless networks (e.g., IEEE 802.11 or cellular networks), the Public Switched Telephone Network (PSTN) network, ad hoc networks, cellular, personal area networks or peer-to-peer (e.g., Bluetooth®, Wi-Fi Direct), or other combinations or permutations of network protocols and network types. Thus, the processing components, communication devices, and interfaces which are provided with the dynamic interaction processing system may utilize any of these communication techniques.

### ADDITIONAL NOTES & EXAMPLES

Example 1 is a method for template-driven distributed electronic transaction data validation, the method comprising: obtaining, at a server, validation rules for validating electronic data to perform a financial transaction with a locality, the validation rules including a payment validation rule, a bank validation rule, and a chronology rule; generating, at the server, an electronic data validation template for the locality using the validation rules, the electronic data validation template including one or more data field definitions for electronic data entry based on the payment validation rule, the bank validation rule, and the chronology rule; and transmitting, to a client device, the electronic data validation template for use in validating electronic data using the one or more data field definitions.

In Example 2, the subject matter of Example 1 optionally includes obtaining rule data from a rule authority data source of the locality; and determining at least one of the payment validation rule or the chronology rule using the rule data.

In Example 3, the subject matter of any one or more of Examples 1-2 optionally include obtaining bank rule data from a bank rule data source of a financial institution; and determining at least one of the payment validation rule, the bank validation rule, or the chronology rule using the bank rule data.

In Example 4, the subject matter of any one or more of Examples 1-3 optionally include wherein the client device is an enterprise resource planning system and the electronic data validation template modifies a display provided by the enterprise resource planning system.

In Example 5, the subject matter of any one or more of Examples 1-4 optionally include wherein the client device is a web server and the electronic data validation template modifies a web page served by the web server.

In Example 6, the subject matter of any one or more of Examples 1-5 optionally include obtaining second validation rules for validating the electronic data; and adaptively modifying the electronic data validation template using the second validation rules.

In Example 7, the subject matter of any one or more of Examples 1-6 optionally include obtaining transaction data and transaction results corresponding to a plurality of transactions for the locality; determining a data field in the transaction data indicated in the transaction results as causing a failure of a plurality of the transactions; analyzing the data field in the transaction data corresponding to each transaction of the plurality of transactions to determine a pattern; and determining the payment validation rule, the bank validation rule, or the chronology rule using the pattern.

In Example 8, the subject matter of any one or more of Examples 1-7 optionally include obtaining transaction data and transaction results corresponding to a plurality of transactions for the locality; determining a value of a data field in the transaction data indicated in the transaction results in causing a failure of a plurality of the transactions; analyzing the value of the data field in the transaction data corresponding to each transaction of the plurality of transactions to determine a pattern; and determining the payment validation rule, the bank validation rule, or the chronology rule using the pattern.

In Example 9, the subject matter of any one or more of Examples 1-8 optionally include obtaining an electronic data file; comparing the electronic data file to the electronic data validation template; and modifying an electronic data field of the electronic data file based on the comparison.

In Example 10, the subject matter of any one or more of Examples 1-9 optionally include obtaining an electronic data file; comparing the electronic data file to the electronic data validation template; and modifying a value of an electronic data field of the electronic data file based on the comparison.

In Example 11, the subject matter of any one or more of Examples 1-10 optionally include wherein the validation rules further include rules for formatting the electronic data in compliance with a SWIFT messaging standard.

In Example 12, the subject matter of any one or more of Examples 1-11 optionally include wherein the validation rules further include rules for formatting the electronic data in compliance with an ISO 15022 messaging standard.

In Example 13, the subject matter of any one or more of Examples 1-12 optionally include wherein the validation rules further include rules for formatting the electronic data in compliance with an ISO 20022 messaging standard.

Example 14 is a method for template-driven distributed electronic transaction data validation, the method comprising electronic operations performed by a client computing device, the electronic operations including: obtaining, from a server, an electronic data validation template for a locality, the electronic data validation template including one or more data field definitions for electronic data entry based on a payment validation rule, a bank validation rule, and a chronology rule; obtaining a data field value for a data field corresponding to the one or more data field definitions; comparing the data field value to the one or more data field definitions; and outputting, for display on a display device, an indication of a modification to the data field value based on the comparing.

In Example 15, the subject matter of Example 14 optionally includes wherein the indication of a modification includes modifying the display of the field data value.

In Example 16, the subject matter of any one or more of Examples 14-15 optionally include wherein the indication of a modification includes displaying a message indicating invalidity of the data field value on the display device.

In Example 17, the subject matter of any one or more of Examples 14-16 optionally include wherein the electronic data validation template is obtained in response to selection of the locality from a locality selection user interface element.

Example 18 is a computer system for template-driven distributed electronic transaction data validation, the computer system comprising processor circuitry configured to: obtain validation rules for validating electronic data to perform a financial transaction with a locality, the validation rules including a payment validation rule, a bank validation rule, and a chronology rule; generate an electronic data validation template for the locality using the validation rules, the electronic data validation template including one or more data field definitions for electronic data entry based on the payment validation rule, the bank validation rule, and the chronology rule; and transmit, to a client device, the electronic data validation template for use in validating electronic data using the one or more data field definitions.

In Example 19, the subject matter of Example 18 optionally includes processor circuitry configured to: obtain rule data from a rule authority data source of the locality; and determine at least one of the payment validation rule or the chronology rule using the rule data.

In Example 20, the subject matter of any one or more of Examples 18-19 optionally include processor circuitry configured to: obtain bank rule data from a bank rule data source of a financial institution; and determine at least one of the payment validation rule, the bank validation rule, or the chronology rule using the bank rule data.

In Example 21, the subject matter of any one or more of Examples 18-optionally include wherein the client device is an enterprise resource planning system and the electronic data validation template modifies a display provided by the enterprise resource planning system.

In Example 22, the subject matter of any one or more of Examples 18-21 optionally include wherein the client device is a web server and the electronic data validation template modifies a web page served by the web server.

In Example 23, the subject matter of any one or more of Examples 18-22 optionally include processor circuitry configured to: obtain second validation rules for validating the electronic data; and adaptively modify the electronic data validation template using the second validation rules.

In Example 24, the subject matter of any one or more of Examples 18-23 optionally include circuitry configured to: obtain transaction data and transaction results corresponding to a plurality of transactions for the locality; determine a data field in the transaction data indicated in the transaction results as causing a failure of a plurality of the transactions; analyze the data field in the transaction data corresponding to each transaction of the plurality of transactions to determine a pattern; and determine the payment validation rule, the bank validation rule, or the chronology rule using the pattern.

In Example 25, the subject matter of any one or more of Examples 18-24 optionally include processor circuitry configured to: obtain transaction data and transaction results corresponding to a plurality of transactions for the locality; determine a value of a data field in the transaction data indicated in the transaction results in causing a failure of a plurality of the transactions; analyze the value of the data field in the transaction data corresponding to each transaction of the plurality of transactions to determine a pattern; and determine the payment validation rule, the bank validation rule, or the chronology rule using the pattern.

In Example 26, the subject matter of any one or more of Examples 18-25 optionally include processor circuitry configured to: obtain an electronic data file; compare the electronic data file to the electronic data validation template; and modify an electronic data field of the electronic data file based on the comparison.

In Example 27, the subject matter of any one or more of Examples 18-26 optionally include processor circuitry configured to: obtain an electronic data file; compare the electronic data file to the electronic data validation template; and modify a value of an electronic data field of the electronic data file based on the comparison.

In Example 28, the subject matter of any one or more of Examples 18-27 optionally include wherein the validation rules further include rules for formatting the electronic data in compliance with a SWIFT messaging standard.

In Example 29, the subject matter of any one or more of Examples 18-28 optionally include wherein the validation rules further include rules for formatting the electronic data in compliance with an ISO 15022 messaging standard.

In Example 30, the subject matter of any one or more of Examples 18-29 optionally include wherein the validation rules further include rules for formatting the electronic data in compliance with an ISO 20022 messaging standard.

Example 31 is at least one computer readable medium including instructions for template-driven distributed electronic transaction data validation that, when executed by a computer, cause the computer to perform operations to: obtain validation rules for validating electronic data to perform a financial transaction with a locality, the validation rules including a payment validation rule, a bank validation rule, and a chronology rule; generate an electronic data validation template for the locality using the validation rules, the electronic data validation template including one or more data field definitions for electronic data entry based on the payment validation rule, the bank validation rule, and the chronology rule; and transmit, to a client device, the electronic data validation template for use in validating electronic data using the one or more data field definitions.

In Example 32, the subject matter of Example 31 optionally includes operations to: obtain rule data from a rule authority data source of the locality; and determine at least one of the payment validation rule or the chronology rule using the rule data.

In Example 33, the subject matter of any one or more of Examples 31-32 optionally include operations to: obtain bank rule data from a bank rule data source of a financial institution; and determine at least one of the payment validation rule, the bank validation rule, or the chronology rule using the bank rule data.

In Example 34, the subject matter of any one or more of Examples 31-33 optionally include wherein the client device is an enterprise resource planning system and the electronic data validation template modifies a display provided by the enterprise resource planning system.

In Example 35, the subject matter of any one or more of Examples 31-34 optionally include wherein the client device is a web server and the electronic data validation template modifies a web page served by the web server.

In Example 36, the subject matter of any one or more of Examples 31-35 optionally include operations to: obtain second validation rules for validating the electronic data; and adaptively modify the electronic data validation template using the second validation rules.

In Example 37, the subject matter of any one or more of Examples 31-36 optionally include circuitry configured to: obtain transaction data and transaction results corresponding to a plurality of transactions for the locality; determine a data field in the transaction data indicated in the transaction results as causing a failure of a plurality of the transactions; analyze the data field in the transaction data corresponding to each transaction of the plurality of transactions to determine a pattern; and determine the payment validation rule, the bank validation rule, or the chronology rule using the pattern.

In Example 38, the subject matter of any one or more of Examples 31-37 optionally include operations to: obtain transaction data and transaction results corresponding to a plurality of transactions for the locality; determine a value of a data field in the transaction data indicated in the transaction results in causing a failure of a plurality of the transactions; analyze the value of the data field in the transaction data corresponding to each transaction of the plurality of transactions to determine a pattern; and determine the payment validation rule, the bank validation rule, or the chronology rule using the pattern.

In Example 39, the subject matter of any one or more of Examples 31-38 optionally include operations to: obtain an electronic data file; compare the electronic data file to the electronic data validation template; and modify an electronic data field of the electronic data file based on the comparison.

In Example 40, the subject matter of any one or more of Examples 31-39 optionally include operations to: obtain an electronic data file; compare the electronic data file to the electronic data validation template; and modify a value of an electronic data field of the electronic data file based on the comparison.

In Example 41, the subject matter of any one or more of Examples 31-40 optionally include wherein the validation rules further include rules for formatting the electronic data in compliance with a SWIFT messaging standard.

In Example 42, the subject matter of any one or more of Examples 31-41 optionally include wherein the validation rules further include rules for formatting the electronic data in compliance with an ISO 15022 messaging standard.

In Example 43, the subject matter of any one or more of Examples 31-42 optionally include wherein the validation rules further include rules for formatting the electronic data in compliance with an ISO 20022 messaging standard.

Example 44 is a client computer system for template-driven distributed electronic transaction data validation, the client computer system comprising processor circuitry configured to: obtain, from a server, an electronic data validation template for a locality, the electronic data validation template including one or more data field definitions for electronic data entry based on a payment validation rule, a bank validation rule, and a chronology rule; obtain a data field value for a data field corresponding to the one or more data field definitions; compare the data field value to the one or more data field definitions; and output, for display on a display device, an indication of a modification to the data field value based on the comparing.

In Example 45, the subject matter of Example 44 optionally includes wherein the indication of a modification includes a modification of the display of the field data value.

In Example 46, the subject matter of any one or more of Examples 44-45 optionally include wherein the indication of a modification includes display of a message indicating invalidity of the data field value on the display device.

In Example 47, the subject matter of any one or more of Examples 44-46 optionally include wherein the electronic data validation template is obtained in response to selection of the locality from a locality selection user interface element.

Example 48 is at least one machine readable medium including instructions for template-driven distributed electronic transaction data validation that, when executed by a computer, cause the computer to perform operations to: obtain, from a server, an electronic data validation template for a locality, the electronic data validation template including one or more data field definitions for electronic data entry based on a payment validation rule, a bank validation rule, and a chronology rule; obtain a data field value for a data field corresponding to the one or more data field definitions; compare the data field value to the one or more data field definitions; and output, for display on a display device, an indication of a modification to the data field value based on the comparing.

In Example 49, the subject matter of Example 48 optionally includes wherein the indication of a modification includes a modification of the display of the field data value.

In Example 50, the subject matter of any one or more of Examples 48-49 optionally include wherein the indication of a modification includes display of a message indicating invalidity of the data field value on the display device.

In Example 51, the subject matter of any one or more of Examples 48-50 optionally include wherein the electronic data validation template is obtained in response to selection of the locality from a locality selection user interface element.

The above description is intended to be illustrative, and not restrictive. For example, the above-described examples (or one or more aspects thereof) may be used in combination with others. Other embodiments may be used, such as by one of ordinary skill in the art upon reviewing the above description. In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer system for template-driven distributed electronic transaction data validation, the computer system comprising processor circuitry configured to:
obtain validation rules for validating electronic data to perform a financial transaction with a locality that covers a geographic area in which the financial transaction is performed, the validation rules including a payment validation rule, a bank validation rule, and a chronology rule, wherein the validation rules are specific to the locality for the geographic area;
generate an electronic data validation template for the locality using the validation rules, the electronic data validation template including one or more data field definitions for electronic data entry based on the payment validation rule, the bank validation rule, and the chronology rule, wherein the electronic data validation template includes field validation computer instructions that, upon execution, validate electronic data entered into an input field generated using the electronic data validation template that corresponds to a data field definition of the one or more data field definitions;
generate a validation rule filter that determines a filtered set of validation rules from the validation rules based on an attribute of a client device;
embed the validation rule filter in the electronic data validation template;
generate validation query instructions, wherein the validation query instructions include a query;
formulate the query using data source query rules included in the validation template, wherein the query queries a data source to validate that elements of the electronic data correspond to data records in the data source;
embed the validation query instructions in the electronic data validation template;
transmit, to a client device, the electronic data validation template for use in validating electronic data using the one or more data field definitions and the filtered set of validation rules upon determination that a transaction scenario includes a transaction with the locality using the electronic data, wherein an input interface of the client device is generated using the electronic data validation template to define validation rules for validation of input entered into an input field of the input interface, and wherein the field validation computer instructions validate the electronic data entered into the input field, the electronic data validation template being separate from the input interface; and
trigger the query based on an action for a data field of the input interface to validate data of the data field using the data source.

2. The computer system of claim 1, further comprising processor circuitry configured to:
obtain rule data from a rule authority data source of the locality; and
determine at least one of the payment validation rule or the chronology rule using the rule data.

3. The computer system of claim 1, further comprising processor circuitry configured to:
obtain bank rule data from a bank rule data source of a financial institution; and
determine at least one of the payment validation rule, the bank validation rule, or the chronology rule using the bank rule data.

4. The computer system of claim 1, wherein the client device is an enterprise resource planning system and the electronic data validation template modifies a display provided by the enterprise resource planning system.

5. The computer system of claim 1, wherein the client device is a web server and the electronic data validation template modifies a web page served by the web server.

6. The computer system of claim 1, further comprising processor circuitry configured to:
obtain second validation rules for validating the electronic data; and
adaptively modify the electronic data validation template using the second validation rules.

7. The computer system of claim 1, further comprising processor circuitry configured to:
obtain transaction data and transaction results corresponding to a plurality of transactions for the locality;
determine a data field in the transaction data indicated in the transaction results as causing a failure of a plurality of the transactions;
analyze the data field in the transaction data corresponding to each transaction of the plurality of transactions to determine a pattern; and
determine the payment validation rule, the bank validation rule, or the chronology rule using the pattern.

8. The computer system of claim 1, further comprising processor circuitry configured to:
obtain transaction data and transaction results corresponding to a plurality of transactions for the locality;
determine a value of a data field in the transaction data indicated in the transaction results in causing a failure of a plurality of the transactions;
analyze the value of the data field in the transaction data corresponding to each transaction of the plurality of transactions to determine a pattern; and
determine the payment validation rule, the bank validation rule, or the chronology rule using the pattern.

9. The computer system of claim 1, further comprising processor circuitry configured to:
obtain an electronic data file;
compare the electronic data file to the electronic data validation template; and
modify an electronic data field of the electronic data file based on the comparison.

10. The computer system of claim 1, further comprising processor circuitry configured to:
obtain an electronic data file;
compare the electronic data file to the electronic data validation template; and
modify a value of an electronic data field of the electronic data file based on the comparison.

11. At least one non-transitory computer readable medium including instructions for template-driven distributed electronic transaction data validation that, when executed by a computer, cause the computer to perform operations to:
obtain validation rules for validating electronic data to perform a financial transaction with a locality that covers a geographic area in which the financial transaction is performed, the validation rules including a payment validation rule, a bank validation rule, and a chronology rule, wherein the validation rules are specific to the locality for the geographic area;
generate an electronic data validation template for the locality using the validation rules, the electronic data validation template including one or more data field definitions for electronic data entry based on the payment validation rule, the bank validation rule, and the chronology rule, wherein the electronic data validation template includes field validation computer instructions that, upon execution, validate electronic data entered into an input field generated using the electronic data validation template that corresponds to a data field definition of the one or more data field definitions;
generate a validation rule filter that determines a filtered set of validation rules from the validation rules based on an attribute of a client device;
embed the validation rule filter in the electronic data validation template;
generate validation query instructions, wherein the validation query instructions include a query;
formulate the query using data source query rules included in the validation template, wherein the query queries a data source to validate that elements of the electronic data correspond to data records in the data source;
embed the validation query instructions in the electronic data validation template;
transmit, to a client device, the electronic data validation template for use in validating electronic data using the one or more data field definitions and the filtered set of validation rules upon determination that a transaction scenario includes a transaction with the locality using the electronic data, wherein an input interface of the client device is generated using the electronic data validation template to define validation rules for validation of input entered into an input field of the input interface, and wherein the field validation computer instructions validate the electronic data entered into the input field, the electronic data validation template being separate from the input interface; and
trigger the query based on an action for a data field of the input interface to validate data of the data field using the data source.

12. The at least one computer readable medium of claim 11, further comprising operations to:
obtain rule data from a rule authority data source of the locality; and
determine at least one of the payment validation rule or the chronology rule using the rule data.

13. The at least one computer readable medium of claim 11, further comprising operations to:
obtain bank rule data from a bank rule data source of a financial institution; and
determine at least one of the payment validation rule, the bank validation rule, or the chronology rule using the bank rule data.

14. The at least one computer readable medium of claim 11, further comprising operations to:
obtain second validation rules for validating the electronic data; and
adaptively modify the electronic data validation template using the second validation rules.

15. The at least one computer readable medium of claim 11, further comprising operations to:
obtain transaction data and transaction results corresponding to a plurality of transactions for the locality;
determine a data field in the transaction data indicated in the transaction results as causing a failure of a plurality of the transactions;
analyze the data field in the transaction data corresponding to each transaction of the plurality of transactions to determine a pattern; and
determine the payment validation rule, the bank validation rule, or the chronology rule using the pattern.

16. The at least one computer readable medium of claim 11, further comprising operations to:
obtain transaction data and transaction results corresponding to a plurality of transactions for the locality;
determine a value of a data field in the transaction data indicated in the transaction results in causing a failure of a plurality of the transactions;
analyze the value of the data field in the transaction data corresponding to each transaction of the plurality of transactions to determine a pattern; and
determine the payment validation rule, the bank validation rule, or the chronology rule using the pattern.

17. The at least one computer readable medium of claim 11, further comprising operations to:
obtain an electronic data file;
compare the electronic data file to the electronic data validation template; and
modify an electronic data field of the electronic data file based on the comparison.

18. The at least one computer readable medium of claim 11, further comprising operations to:
obtain an electronic data file;
compare the electronic data file to the electronic data validation template; and
modify a value of an electronic data field of the electronic data file based on the comparison.

19. The at least one computer readable medium of claim 11, wherein the validation rules further include rules for formatting the electronic data in compliance with a SWIFT messaging standard.

20. The at least one computer readable medium of claim 11, wherein the validation rules further include rules for formatting the electronic data in compliance with an ISO 15022 messaging standard.

21. The at least one computer readable medium of claim 11, wherein the validation rules further include rules for formatting the electronic data in compliance with an ISO 20022 messaging standard.

22. A method for template-driven distributed electronic transaction data validation, the method comprising:
obtaining, at a server, validation rules for validating electronic data to perform a financial transaction with a locality that covers a geographic area in which the financial transaction is performed, the validation rules including a payment validation rule, a bank validation rule, and a chronology rule, wherein the validation rules are specific to the locality for the geographic area;
generating, at the server, an electronic data validation template for the locality using the validation rules, the electronic data validation template including one or more data field definitions for electronic data entry based on the payment validation rule, the bank validation rule, and the chronology rule, wherein the electronic data validation template includes field validation computer instructions that, upon execution, validate electronic data entered into an input field generated using the electronic data validation template that corresponds to a data field definition of the one or more data field definitions;
generating a validation rule filter that determines a filtered set of validation rules from the validation rules based on an attribute of a client device;
embedding the validation rule filter in the electronic data validation template;
generating validation query instructions, wherein the validation query instructions include a query;
formulating the query using data source query rules included in the validation template, wherein the query queries a data source to validate that elements of the electronic data correspond to data records in the data source;
embedding the validation query instructions in the electronic data validation template
transmitting, to a client device, the electronic data validation template for use in validating electronic data using the one or more data field definitions and the filtered set of validation rules upon determination that a transaction scenario includes a transaction with the locality using the electronic data, wherein an input interface of the client device is generated using the electronic data validation template to define validation rules for validation of input entered into an input field of the input interface, and wherein the field validation computer instructions validate the electronic data entered into the input field, the electronic data validation template being separate from the input interface; and
triggering the query based on an action for a data field of the input interface to validate data of the data field using the data source.

23. The method of claim 22, further comprising:
obtaining rule data from a rule authority data source of the locality; and
determining at least one of the payment validation rule or the chronology rule using the rule data.

24. The method of claim 22, further comprising:
obtaining bank rule data from a bank rule data source of a financial institution; and
determining at least one of the payment validation rule, the bank validation rule, or the chronology rule using the bank rule data.

25. The method of claim 22, further comprising:
obtaining second validation rules for validating the electronic data; and
adaptively modifying the electronic data validation template using the second validation rules.

26. The method of claim 22, further comprising:
obtaining transaction data and transaction results corresponding to a plurality of transactions for the locality;
determining a data field in the transaction data indicated in the transaction results as causing a failure of a plurality of the transactions;
analyzing the data field in the transaction data corresponding to each transaction of the plurality of transactions to determine a pattern; and
determining the payment validation rule, the bank validation rule, or the chronology rule using the pattern.

27. The method of claim 22, further comprising:
obtaining transaction data and transaction results corresponding to a plurality of transactions for the locality;
determining a value of a data field in the transaction data indicated in the transaction results in causing a failure of a plurality of the transactions;
analyzing the value of the data field in the transaction data corresponding to each transaction of the plurality of transactions to determine a pattern; and
determining the payment validation rule, the bank validation rule, or the chronology rule using the pattern.

28. The method of claim 22, further comprising:
obtaining an electronic data file;
comparing the electronic data file to the electronic data validation template; and
modifying an electronic data field of the electronic data file based on the comparison.

29. The method of claim 22, further comprising:
obtaining an electronic data file;
comparing the electronic data file to the electronic data validation template; and
modifying a value of an electronic data field of the electronic data file based on the comparison.
